(19) United States
(12) Patent Application Publication
(10) Pub. No.: US 2013/0176008 A1
(43) Pub. Date: Jul. 11, 2013

(54) Soft Start Circuit and Power Supply Device Using the Same

(71) Applicants: Chih-Chen Li, Hsinchu County (TW); Chin-Hsun Chen, Hsinchu County (TW)

(72) Inventors: Chih-Chen Li, Hsinchu County (TW); Chin-Hsun Chen, Hsinchu County (TW)

(21) Appl. No.: 13/345,764

(22) Filed: Jan. 9, 2012

(51) Int. Cl. G05F 1/46

(52) U.S. Cl. 323/273; 323/282; 323/280

(57) ABSTRACT

The present invention discloses a soft start circuit for a power supply device comprising an external P-type transistor for charging an output capacitor to provide an output voltage. The soft start circuit includes a current source, for providing a discharge current; and a disabling means, coupled to the current source, for discharging an equivalent total parasitic capacitor of the external P-type transistor during an activation period according to the discharge current.

### BACKGROUND OF THE INVENTION

1. Field of the Invention

The present invention relates to a soft start circuit and power supply device using the same, and more particularly, to a soft start circuit and power supply device using the same capable of effectively reducing inrush current during an activation period without increasing chip area or requiring extra pins.

2. Description of the Prior Art

Power supply devices play an essential role in modern information technology. Among all the power supply devices, DC-DC switching regulators are very popular and are widely used for providing regulated DC power sources to electronic components.

Please refer to FIG. 1A, which is a schematic diagram of a conventional DC-DC switching regulator 10. The DC-DC switching regulator 10 provides a steady output voltage VOUT to a load RL, and includes an external P-type transistor 100, an external N-type transistor 102, an inductor L, an output capacitor C, a comparator 104, a pulse width modulation (PWM)/pulse frequency modulation (PFM) control loop 106, a dead time control 108 and a buffer 110. In FIG. 1A, the external P-type transistor 100, the external N-type transistor 102, the inductor L, and the output capacitor C are off-chip, while the PWM/PFM control loop 106, the dead time control 108 and the buffer 110 are on-chip. Under such a configuration, since the external P-type transistor 100 and the external N-type transistor 102 are off-chip, the DC-DC switching regulator 10 can provide a high output current without increasing chip area and heating.

In short, when the output voltage VOUT is less than a reference voltage VREF, the comparator 104 outputs an enable signal ENA for the PWM/PFM control loop 106 to trigger an on-time period, so as to turn on the external P-type transistor 100 and turn off the external N-type transistor 102 during the on-time period. Thus, an external voltage source VDD can deliver electrical energy to the inductor L via the external P-type transistor 100 to output a charging current IL to charge the output capacitor C, i.e. a charge path CP, such that the output voltage VOUT, i.e. a voltage across the output capacitor C, increases.

On the other hand, when the output voltage VOUT is greater than the reference voltage VREF, the external P-type transistor 100 is turned off and the external N-type transistor 102 is turned on, such that the output capacitor C is discharged to a ground, i.e. a discharge path DCP, and thus the output voltage VOUT starts falling. In other words, when the external P-type transistor 100 is turned off, the output voltage VOUT of the DC-DC switching regulator 10 starts falling, and then the external P-type transistor 100 is turned on again until the output voltage VOUT is less than the reference voltage VREF. As a result, the DC-DC switching regulator 10 can adjust the electrical energy delivered to the load RL by controlling operations of the external P-type transistor 100 and the external N-type transistor 102 to provide the steady output voltage VOUT.

Noticeably, the dead time control 108 adjusts control signals received from the PWM/PFM control loop 106 to prevent the external P-type transistor 100 and the external N-type transistor 102 from simultaneously conducting, i.e. a short current from the external voltage source VDD to the ground. The buffer 110 amplifies control signals received from the dead time control 108 to drive the external P-type transistor 100 and the external N-type transistor 102, which have large sizes for providing the high output current.

However, under such a feedback configuration, during an activation period, since the DC-DC switching regulator 10 is just activated and the voltage across the output capacitor C, i.e. the output voltage VOUT, is zero, the comparator 104 may outputs the enable signal ENA for the PWM/PFM control loop 106 to continually trigger on-time periods, such that the external P-type transistor 100 is continually fully turned on. Therefore, since the voltage across the output capacitor C is zero or low during the activation period, a large inrush current occurs and thus damages devices.

Under such a situation, a soft start mechanism can be added to the DC-DC switching regulator 10 to slowly turn on the external P-type transistor 100 and thus charge the output capacitor C with a smaller current during the activation period, so as to avoid damaging devices. Please refer to FIG. 1B and FIG. 1C, which are schematic diagrams of the charging current IL and the output voltage VOUT of the DC-DC switching regulator 10 without/with a soft start mechanism, respectively. As shown in FIG. 1B and FIG. 1C, if the DC-DC switching regulator 10 does not include the soft start mechanism, there is an inrush current during the activation period as shown in FIG. 1B, while there is no inrush current during the activation period if the DC-DC switching regulator 10 includes the soft start mechanism as shown in FIG. 1C.

In a conventional soft start mechanism, an extra on-chip capacitor is added and slowly charged to provide the reference voltage VREF, and thus a voltage difference between the initial reference voltage VREF and the initial output voltage VOUT is less, which can slowly turn on the external P-type transistor 100 but increases chip area since the extra on-chip capacitor is large.

In another conventional soft start mechanism, an extra off-chip current sense circuit is added to sense the charging current IL of the external P-type transistor 100, and thus the DC-DC switching regulator 10 can perform feedback according to the sensed charging current IL, which clamps the charging current IL to avoid the inrush current but requires extra pins for the extra off-chip current sense circuit.

However, the conventional soft start mechanism either increases chip area with a large on-chip capacitor or requires extra pins for the off-chip current sense circuit. Thus, there is a need for improvement over the prior art.

### SUMMARY OF THE INVENTION

It is therefore an objective of the present invention to provide a soft start circuit and power supply device using the same capable of effectively reducing inrush current during an activation period without increasing chip area or requiring extra pins.

The present invention discloses a soft start circuit for a power supply device comprising an external P-type transistor for charging an output capacitor to provide an output voltage. The soft start circuit includes a current source, for providing a discharge current; and a disabling means, coupled to the current source, for discharging an equivalent total parasitic capacitor of the external P-type transistor during an activation period according to the discharge current.

The present invention further discloses a soft start circuit for a power supply device comprising an external P-type transistor for charging an output capacitor to provide an output voltage. The soft start circuit includes a transistor, comprising a control terminal, a first terminal and a second terminal; an operational amplifier, comprising a first input terminal for receiving a reference voltage, a second input terminal coupled to the second terminal of the transistor, and an output terminal coupled to the control terminal of the transistor; and a disabling means, coupled between the second terminal of the transistor and the second input terminal of the operational amplifier, and a second terminal a gate of the external P-type transistor, for clamping a voltage of a equivalent total parasitic capacitor at the reference voltage during an activation period.

The present invention further discloses a power supply device. The power supply device includes an external P-type transistor for charging an output capacitor to provide an output voltage; a first soft start circuit, for discharging a equivalent total parasitic capacitor of the external P-type transistor during an activation period; and a second soft start circuit, for clamping a voltage of the equivalent total parasitic capacitor at a reference voltage during an activation period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a conventional DC-DC switching regulator.

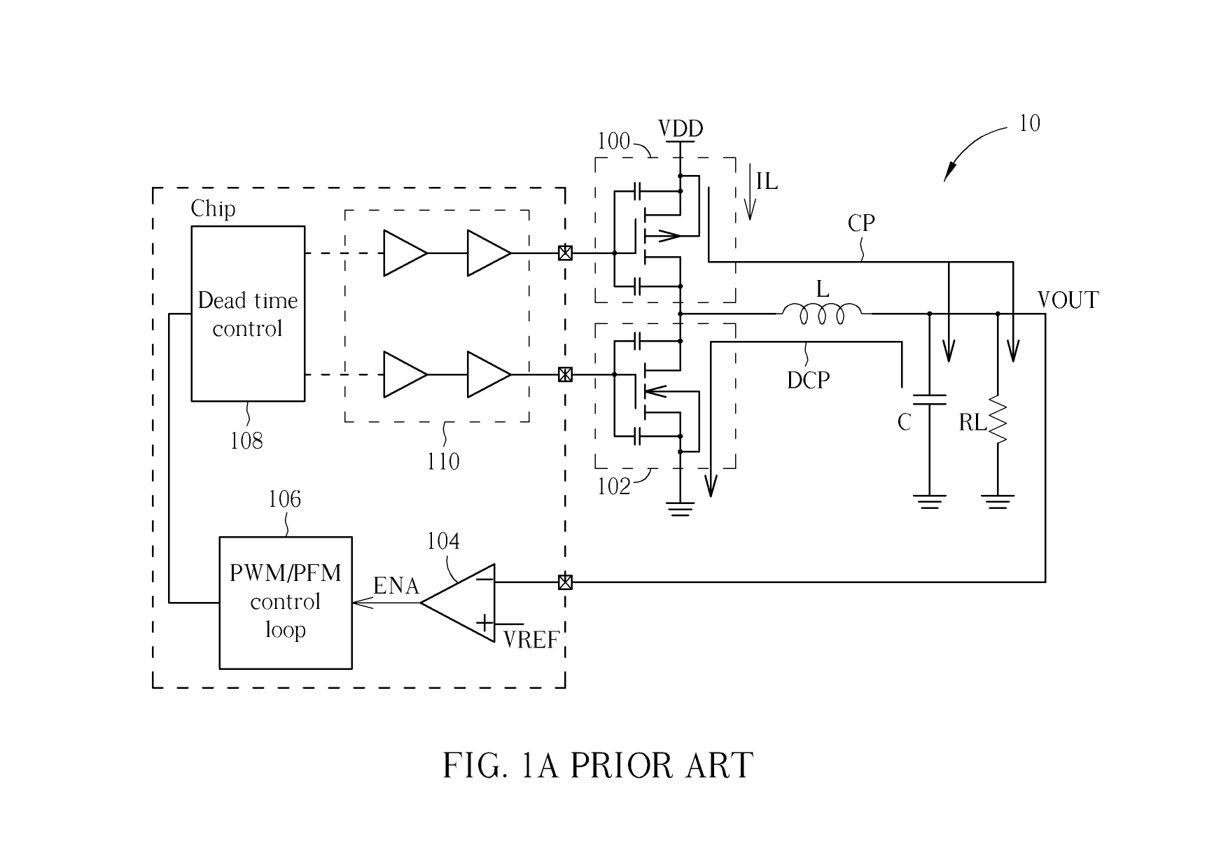

FIG. 1B and FIG. 1C are schematic diagrams of a charging current and an output voltage of the DC-DC switching regulator shown in FIG. 1A without/with a soft start mechanism, respectively.

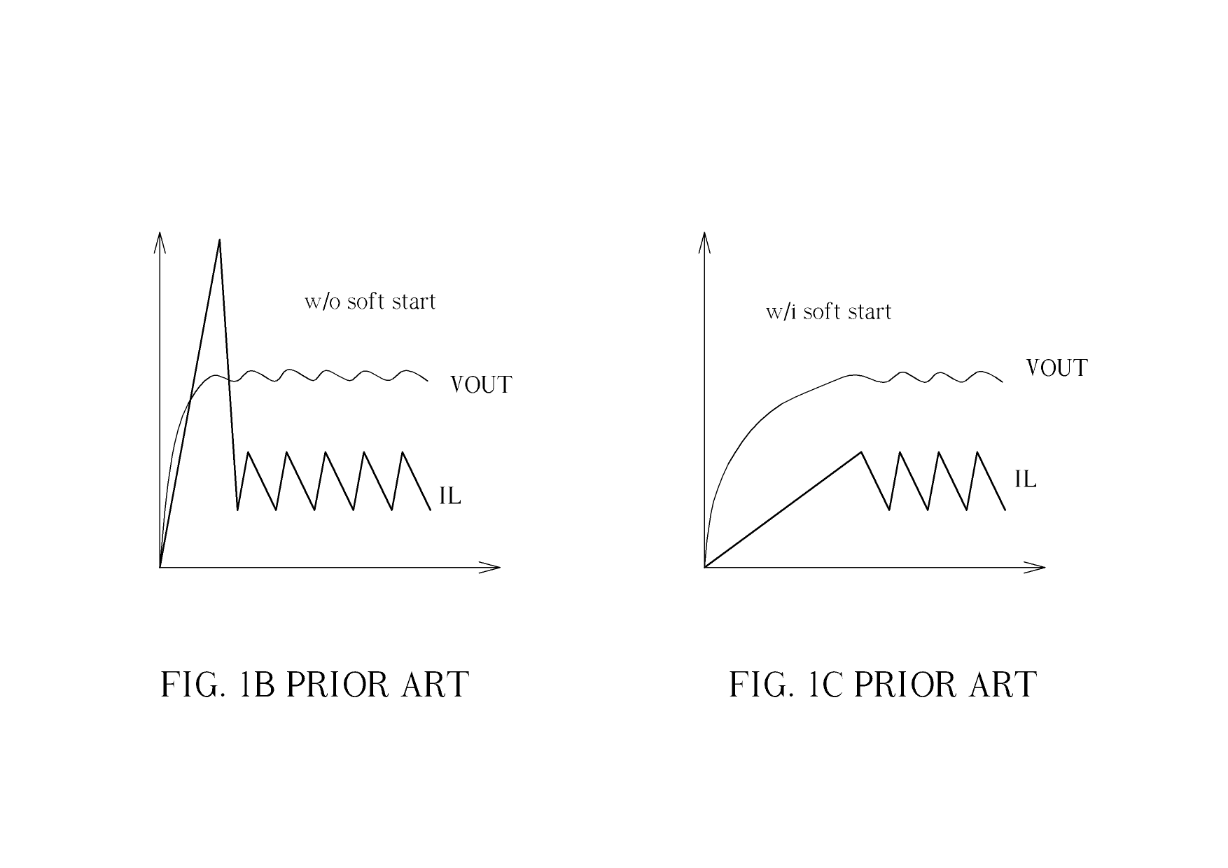

FIG. 2A is a schematic diagram of a DC-DC switching regulator according to an embodiment of the present invention.

FIG. 2B is a schematic diagram of an external voltage source, a voltage PWMP, an output voltage and a charging current shown in FIG. 2A according to an embodiment of the present invention.

### DETAILED DESCRIPTION

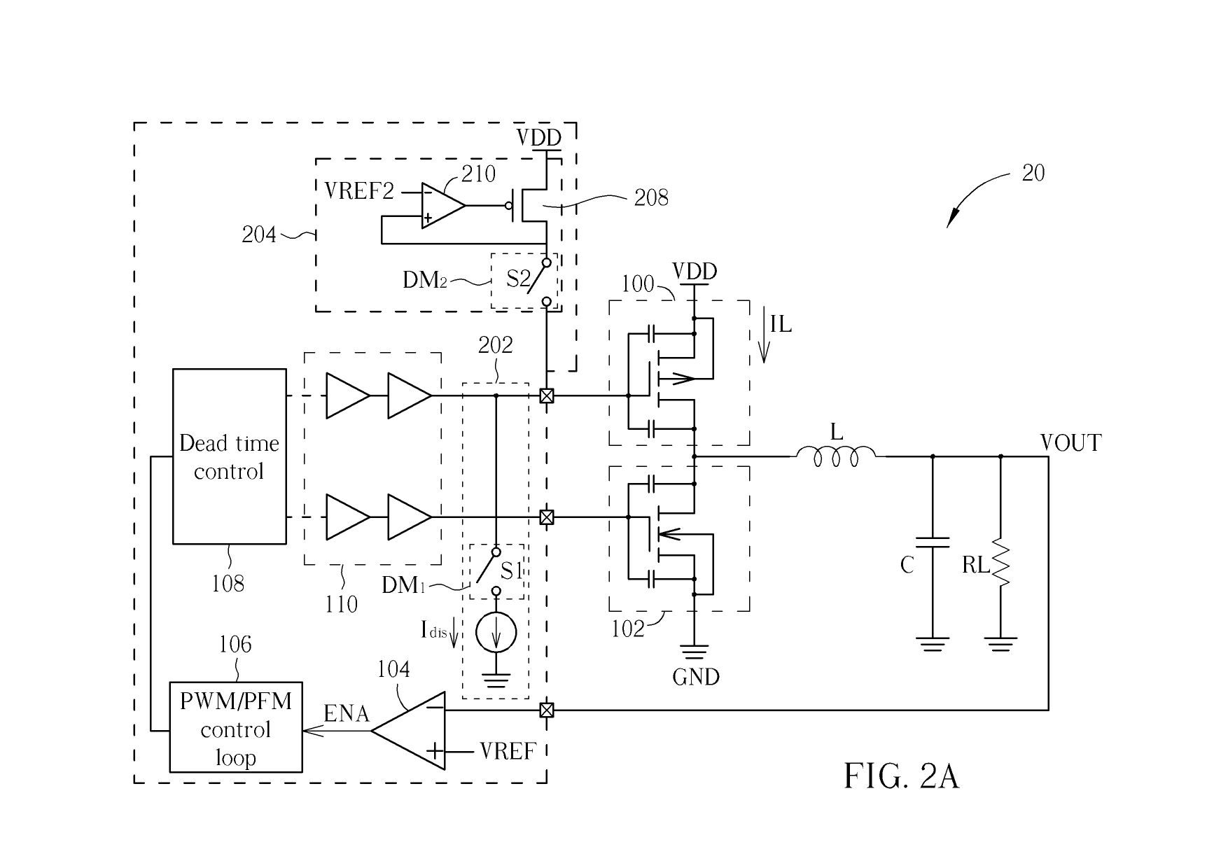

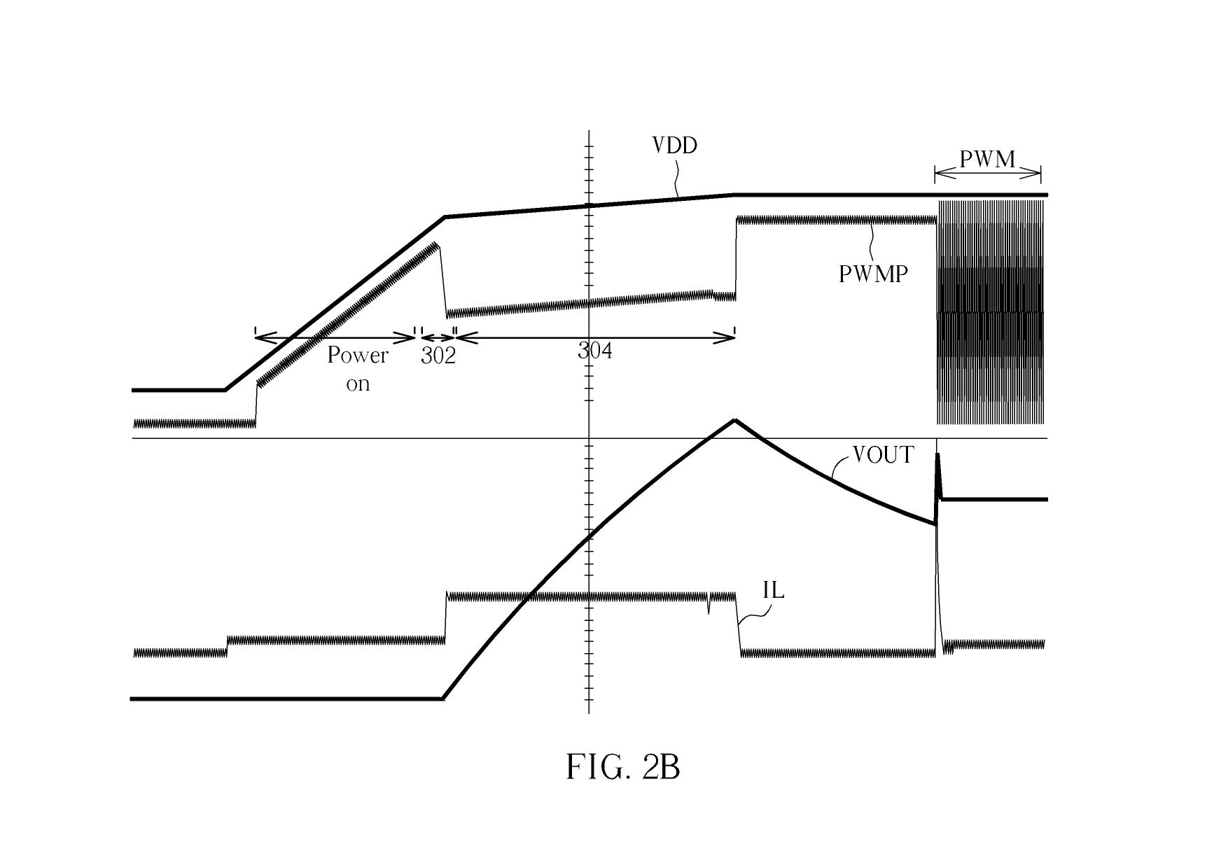

Please refer to FIG. 2A, which is a schematic diagram of a DC-DC switching regulator 20 according to an embodiment of the present invention. The structure and operating principles of the DC-DC switching regulator 20 are similar to those of the DC-DC switching regulator 10, such that elements and signals with similar functions are denoted with the same symbols for simplicity. Differences between the DC-DC switching regulator 20 and the DC-DC switching regulator 10 are that the DC-DC switching regulator 20 includes soft start circuits 202 and 204. The soft start circuit 202 discharges an equivalent total parasitic capacitor of the external P-type transistor 100 during an activation period, and the soft start circuit 204 clamps a voltage PWMP of the equivalent total parasitic capacitor, i.e. a gate voltage of the external P-type transistor 100, higher than or equal to a reference voltage VREF2 during the activation period. Noticeably, the equivalent total parasitic capacitor is equivalent to parasitic capacitors coupled between the gate and other terminals of the external P-type transistor 100, and the soft start circuits 202, 204 are on-chip. As a result, the DC-DC switching regulator 30 can slowly turn on the external P-type transistor 100 and clamp the charging current IL to prevent an inrush current from damaging devices without increasing chip area or requiring extra pins.

In detail, please refer to FIG. 2B, which is a schematic diagram of the external voltage source VDD, the voltage PWMP, the output voltage VOUT and the charging current IL shown in FIG. 2A according to an embodiment of the present invention. As shown in FIG. 2B, at a start of the activation period, i.e. power on, the equivalent total parasitic capacitor of the external P-type transistor 100 is charged to a high voltage level to turn off the external P-type transistor 100 first. Afterwards, the soft start circuit 202 discharges the equivalent total parasitic capacitor from the high voltage level to the reference voltage VREF2 to slowly turn on the external P-type transistor 100, and then the soft start circuit 204 clamps the voltage PWMP of the equivalent total parasitic capacitor higher than or equal to the reference voltage VREF2 during the activation period. Under such a situation, there is no inrush current during the activation period and the voltage across the output capacitor C, i.e. the output voltage VOUT, can be charged slowly and steadily.

Noticeably, the DC-DC switching regulator 20 does not perform feedback to control the external P-type transistor 100 and the external N-type transistor 102 during the activation period, i.e. disable the comparator 104, the pulse width modulation (PWM)/pulse frequency modulation (PFM) control loop 106, the dead time control 108 and the buffer 110, and performs feedback to output the steady output voltage VOUT by driving the external P-type transistor 100 and the external N-type transistor 102 with PWM signals after the activation period.

Specifically, please continue to refer to FIG. 2A. As shown in FIG. 2A, the soft start circuit 202 includes a current source 206 and a disabling means DM₁, e.g. a switch S1 in this embodiment. The current source 206 is coupled to a voltage level lower than a gate voltage of the external P-type transistor 100, e.g. a ground in this embodiment, and provides a discharge current I_{dis}. The switch S1 is coupled between the current source 206 and the gate of the external P-type transistor 100. Under such a configuration, during the activation period, the switch 51 is switched on to conduct to discharge the equivalent total parasitic capacitor according to the discharge current I_{dis}. Noticeably, the disabling means DM₁ can be realized by other components capable of enabling or disabling the current source 206 to discharge the equivalent total parasitic capacitor, e.g. a transistor. As a result, the soft start circuit 202 can slowly discharge the equivalent total parasitic capacitor of the external P-type transistor 100 during the activation period.

On the other hand, the soft start circuit 204 includes a transistor 208, an operational amplifier 210 and a disabling means DM₂, e.g. a switch S2 in this embodiment. The operational amplifier 210 includes a negative input terminal for receiving the reference voltage VREF2, a positive input terminal coupled to a drain of the transistor 208, and an output terminal coupled to a gate of the transistor 208. The switch S2 includes a first terminal coupled between the drain of the transistor 208 and the positive input terminal of the operational amplifier 210, and a second terminal coupled to the gate of the external P-type transistor 100.

Under such a configuration, during the activation period, the switch S2 is switched on to conduct to clamp the voltage PWMP of the equivalent total parasitic capacitor higher than or equal to the reference voltage VREF2. That is, when a drain voltage of the transistor 208 (i.e. the voltage PWMP) is lower than the reference voltage VREF2, the operational amplifier 210 outputs a low voltage level signal to turn on the transistor 208, such that the external voltage source VDD can charge the equivalent total parasitic capacitor until the voltage PWMP is higher than the reference voltage VREF2. Noticeably, the disabling means DM₂ can be realized by other components capable of enabling or disabling the transistor 208 and the operational amplifier 210 to clamp the voltage PWMP of the equivalent total parasitic capacitor higher than or equal to the reference voltage VREF2, e.g. a transistor or a component for switching off the transistor 208. As a result, the soft start circuit 204 clamps a voltage PWMP of the equivalent total parasitic capacitor, i.e. a gate voltage of the external P-type transistor 100, higher than or equal to a reference voltage VREF2 during the activation period.

Noticeably, the spirit of the present invention is to slowly discharge the existing equivalent total parasitic capacitor of the external P-type transistor 100 to slowly turn on the external P-type transistor 100 by the on-chip soft start circuit 202, and to clamp the voltage PWMP of the equivalent total parasitic capacitor as well as the charging current IL by the on-chip soft start circuit 204, so as to prevent the inrush current from damaging devices without increasing chip area or requiring extra pins. Those skilled in the art should make modifications or alterations accordingly.

For example, the soft start circuits 202, 204 are applied in the DC-DC switching regulator 20 (e.g. buck, boost, buck-boost), but can also be applied in other power supply devices which need to slowly turn on the P-type transistor to prevent the inrush current such as a low dropout regulator (LDO). Besides, the soft start circuits 202, 204 are applied in the DC-DC switching regulator 20 as a whole in the DC-DC switching regulator 20, but can also be separately applied, as long as the soft start circuit 202 can slowly discharge the equivalent total parasitic capacitor of the external P-type transistor 100 and the soft start circuit 204 clamps the voltage PWMP of the equivalent total parasitic capacitor. Moreover, components of the soft start circuits 202, 204 are not limited to components shown in FIG. 2A, and can be realized by other components, e.g. the current source 206 can be replaced by a resistor to discharge the equivalent total parasitic capacitor via a RC circuit, the transistor 208 can be a metal oxide semiconductor (MOS) transistor but can also be realized by other types of transistor as well.

In the prior art, the conventional soft start mechanism either increases chip area with a large on-chip capacitor or requires extra pins for the off-chip current sense circuit. In comparison, the present invention slowly discharges the existing equivalent total parasitic capacitor of the external P-type transistor 100 to slowly turn on the external P-type transistor 100 by the on-chip soft start circuit 202, and to clamp the voltage PWMP of the equivalent total parasitic capacitor as well as the charging current IL by the on-chip soft start circuit 204, so as to prevent the inrush current from damaging devices without increasing chip area or requiring extra pins.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A soft start circuit for a power supply device comprising an external P-type transistor for charging an output capacitor to provide an output voltage, the soft start circuit comprising:
a current source, for providing a discharge current; and
a disabling means, coupled to the current source, for discharging an equivalent total parasitic capacitor of the external P-type transistor during an activation period according to the discharge current.

2. The soft start circuit of claim 1, wherein the equivalent total parasitic capacitor is charged to a high voltage level to turn off the external P-type transistor first at a start of the activation period, and then discharged from the high voltage level to a ground level during the activation period.

3. The soft start circuit of claim 1, wherein the power supply device does not perform feedback to control the external P-type transistor during the activation period.

4. The soft start circuit of claim 1, wherein the power supply device is a DC-DC switching regulator, or a low dropout regulator (LDO).

5. The soft start circuit of claim 1, wherein the disabling means comprises a switch.

6. The soft start circuit of claim 1, wherein the disabling means comprises a transistor.

7. The soft start circuit of claim 1, wherein the current source is coupled to a ground.

8. A soft start circuit for a power supply device comprising an external P-type transistor for charging an output capacitor to provide an output voltage, the soft start circuit comprising:
a transistor, comprising a control terminal, a first terminal and a second terminal;
an operational amplifier, comprising a first input terminal for receiving a reference voltage, a second input terminal coupled to the second terminal of the transistor, and an output terminal coupled to the control terminal of the transistor; and
a disabling means, coupled between the second terminal of the transistor and the second input terminal of the operational amplifier, and a gate of the external P-type transistor, for clamping a voltage of an equivalent total parasitic capacitor higher than or equal to the reference voltage during an activation period.

9. The soft start circuit of claim 8, wherein the power supply device does not perform feedback to control the external P-type transistor during the activation period.

10. The soft start circuit of claim 8, wherein the power supply device is a DC-DC switching regulator, or a low dropout regulator (LDO).

11. The soft start circuit of claim 8, wherein the disabling means comprises a switch.

12. The soft start circuit of claim 8, wherein the disabling means comprises a transistor.

13. A power supply device, comprising:
an external P-type transistor for charging an output capacitor to provide an output voltage;
a first soft start circuit, for discharging a equivalent total parasitic capacitor of the external P-type transistor during an activation period; and
a second soft start circuit, for clamping a voltage of the equivalent total parasitic capacitor higher than or equal to a reference voltage during an activation period.

14. The power supply device of claim 13, wherein the equivalent total parasitic capacitor of the external P-type transistor is charged to a high voltage level to turn off the external P-type transistor first at a start of the activation period, and the first soft start circuit discharges the equivalent total parasitic capacitor from the high voltage level to the reference voltage and then second soft start circuit clamps the voltage of the equivalent total parasitic capacitor higher than or equal to the reference voltage during the activation period.

15. The power supply device of claim 13, wherein the power supply device does not perform feedback to control the external P-type transistor during the activation period.

16. The power supply device of claim 13, wherein the first soft start circuit comprises:
a current source, coupled to a ground, for providing a discharge current; and
a disabling means, coupled to the current source, for discharging the equivalent total parasitic capacitor during the activation period according to the discharge current.

17. The power supply device of claim 16, wherein the first disabling means comprises a switch or a transistor.

18. The power supply device of claim 16, wherein the current source is coupled to a ground.

19. The power supply device of claim 13, wherein the second soft start circuit comprises:
a transistor, comprising a control terminal, a first terminal and a second terminal;
an operational amplifier, comprising a first input terminal for receiving the reference voltage, a second input terminal coupled to the second terminal of the transistor, and an output terminal coupled to the control terminal of the transistor; and
a second disabling means, coupled between the second terminal of the transistor and the second input terminal of the operational amplifier, and the gate of the external P-type transistor, for clamping the voltage of the equivalent total parasitic capacitor higher than or equal to the reference voltage during the activation period.

20. The power supply device of claim 16, wherein the second disabling means comprises a switch or a transistor.

21. The power supply device of claim 13, wherein the power supply device is a DC-DC switching regulator, or a low dropout regulator (LDO).
